(19) United States
(12) Patent Application Publication
(10) Pub. No.: US 2018/0301047 A1
(43) Pub. Date: Oct. 18, 2018

(54) Method Quantify Users' Expertise Through their Interaction with Different Applications

(71) Applicant: Mita Das Mayoraz, Cupertino, CA (US)

(72) Inventor: Mita Das Mayoraz, Cupertino, CA (US)

(73) Assignee: Zapptitude, Inc., Cupertino, CA (US)

(21) Appl. No.: 15/490,888

(22) Filed: Apr. 18, 2017

(51) Int. Cl. G09B 5/12; G09B 7/10; A63F 3/04; G09B 7/07; A63F 13/85

(52) U.S. Cl. CPC G09B 5/125; G09B 7/10; A63F 13/85; G09B 7/07; A63F 3/04

(57) ABSTRACT

The subject of this patent is a system and method for assessing students' understanding while they are interacting with a plurality of third party educational systems. The system comprises (1) an application program interface (API) that allow any educational content provider to instrument their content with the proposed system, so that the interaction of students with the content can be tracked; (2) an inference engine that gathers and analyzes interactions across multiple students and a broad array of content, and infers both, the difficulty of each piece of content, and the understanding of each student; (3) a reporting tool for students or for educators following a group of students, expressing the level of understanding of each student and its progression over time.

The advantages of this system and method are: offering an assessment as a service solution to educational content providers, saving them time and effort to build this essential component themselves; a measure and assessment of understanding at the time of learning instead of via post-learning tests; a holistic and more accurate view and reporting of a student skill level and understanding provided by analyzing her interaction with a plurality of educational content instead of multiple independent reports based on individual education content.

### CROSS-REFERENCE TO RELATED APPLICATIONS

This application claims the benefit of provisional patent application No. 62/324,027 filed Apr. 18, 2016, by the present inventor.

### FEDERALLY SPONSORED RESEARCH

Not Applicable

### SEQUENCE LISTING OR PROGRAM

Not Applicable

### BACKGROUND OF THE INVENTION

### Field Of Invention

The present invention is related to the field of digital educational systems running on individual digital devices, in particular educational applications, puzzles, games, and the problem of reliable assessment tools to measure the effectiveness of digital learning technologies. The aim of this invention is to provide a system to quantify the understanding of a user about a specific subject through his or her interaction with one or more applications; the measure being reported in a scale specific to the field but independent of the applications.

### Related Art

The advent of mobile devices and digital learning tools and apps create promising opportunities for developing new learning technologies to deliver academic content that is more engaging, adaptive, relevant and rigorous. Growing evidence demonstrates that digital apps/games can be used to advance standards-based content mastery in science, literacy and math, plus build critical real world skills such as persistence, systems thinking and problem solving that are essential for preparing young people for success in a global and digital marketplace. However, a fundamental obstacle remains: the effectiveness of digital learning technologies such as game/app based learning is rarely known due to lack of reliable assessment tools.

Regular assessments during the learning process help educators to evaluate student understanding, and determine where specifically they require support and how to provide it. Some educators use digital assessment tools to create formative tests and quizzes intended to uncover what concepts the student has mastered or where he needs remedial support. In addition, most educational games and apps come with reporting tools embedded in each product to inform them of a student's progress. These assessments have the potential to provide insights into why students are having difficulties in mastering concepts and how to personalize feedback to address these challenges. Embedded assessments can allow educators to see evidence of students' thinking during the learning process and provide near real-time feedback through learning dashboards so they can identify problem areas and take action in the moment. However, as each product has its own reporting, it is difficult to gather data from multiple apps and games for a unified assessment. Multiple reports from multiple apps add unnecessary burden on teachers. Currently, no solutions exist in the market for cross-app assessment as a benchmarking tool in a single centralized dashboard.

Simultaneously, app developers face an increasingly crowded marketplace, issues of discoverability and ever changing app business landscape. It is also expensive to compete for visibility against big budgeted, established brands. Further, for educational apps, it is costly to have educators endorse or scientifically validate the learning benefits of the apps.

Given the above, what is needed is a system, method and computer program product for a real-time formative assessment designed for educators that can deliver reporting via a single dashboard that is consistent across any app, game, test and quiz that plugs into this system, providing them with instant, simple, actionable insight. The ability to offer formative assessments at the point of learning and identify each student's strengths, weaknesses and learning gaps in real-time will enhance teacher's ability to more effectively target personalized instruction to serve all kinds of learners and learning styles and save them valuable time.

Through innovative education technology, solutions for different pain points around digital learning and digital, real-time assessment are being addressed.

A list of relevant citations is provided below:
U.S. Pat. No. 5,779,486A—Methods and apparatus to assess and enhance a student's understanding in a subject.
U.S. Pat. No. 7,114,126B2—System and method for real-time observation assessment
U.S. Pat. No. 6,988,138B1—Internet-based education support system and methods
U.S. Pat. No. 5,823,788A—Interactive educational system and method
U.S. Pat. No. 5,879,165A—Method for comprehensive integrated assessment in a course of study or occupation
U.S. Pat. No. 5,947,747A—Method and apparatus for computer-based educational testing
U.S. Pat. No. 20120040326A1—Methods and systems for optimizing individualized instruction and assessment

### SUMMARY OF THE INVENTION

The present invention addresses the above-identified pain points by providing a system, method and a cloud-based computer program product for real-time assessment from a plurality of applications from various educational system providers to deliver a unified reporting.

The system of the present invention consists of a software development kit for educational system providers to instrument their solution with the proposed system, an inference engine that gathers and analyzes interactions across multiple students and a broad array of educational systems, and infers both the difficulty of each piece of educational content as well as the understanding of each student and generates reports on demand.

The method and computer program product of the present invention allows users (students, parents, teachers, educators, administrators, educational system providers) to visit a central web site, where they can register individually and create unique IDs with no personally identifiable information. Teachers and educators can register individually or as part of a school or school district. Once registered, teachers/educators can assign unique IDs to their students, choose appropriate educational content or application(s) for their subject and grade level from numerous available web sites, apps, games, tests and quizzes from various educational systems for their students to interact with. If need be, they then download these applications and install them on to digital devices.

As students interact with these digital learning systems, data is logged and sent instantly to a secure cloud server as long as there is internet connectivity. Data is saved in the absence of—or interruption of—the internet connectivity and sent over as soon as a connection is established. The inference engine analyzes the data in real-time and sends back report on the performance of the learner which can be accessed online by the users using their sign-on credentials. When teachers are part of a school or school district license, data and reports maybe shared with other educators and parents within the school system.

Taking the assessment and reporting out of each educational system and offering it as a service offers several advantages, for the student, the educator, and the educational system provider.

An advantage of the present invention is that it allows for assessing a student from his/her activity across multiple educational systems which leads to a more accurate, comprehensive, and relevant picture of his/her current level of understanding of a concept. By contrast, a silo assessment solution developed within a specific educational system can be tailored to the specific system, but remains limited to its narrow view of the student's activity within that system.

Another advantage of this invention is a unique assessment and reporting solution across educational systems that saves precious time for educators and frees the schools and districts from the dilemma of either being locked in a unique educational solution provider or adding more burden on educators by asking them to manage and monitor multiple report sources.

An advantage of this invention for educational system providers like app developers is that relieved from the burden of developing assessment and reporting tools for each app, they can focus their resources on building highly engaging, entertaining educational apps.

Another advantage of this invention is that real time reports on the data inferred difficulty of each app and each individual question within the app enables the app developer to bring to their app an unparalleled level of adaptive learning and personalization.

Yet another advantage of the present invention is that it allows for stealth mode assessment, i.e., it is non-intrusive and not disruptive to students. The teacher has an instant view of the learner's understanding of the subject or concept and can offer remedial support at the point of learning if needed.

The system's architecture, structure and operation is described in detail below with reference to the accompanying drawings.

### BRIEF DESCRIPTION OF DRAWINGS—FIGURES

FIG. 1 is a block diagram illustrating the operational architecture of an embodiment of the present invention for a real-time assessment system across educational systems and across users, showing connectivity among the various components of the system.

FIG. 2 is a block diagram illustrating in more detail, according to an embodiment of the present invention, portions of the architecture shown in FIG. 1.

FIG. 3 is a flow chart depicting an embodiment of the operational process of student registration, data logging and reporting.

FIG. 4 is a flow chart depicting an embodiment of the operational process of teacher registration, creating a class roster and assigning students with unique IDs.

FIG. 5 is a flow chart depicting an embodiment of the operational process of educational system provider registration, data logging and reporting.

FIG. 6 is a flow chart depicting an embodiment of the operational process of teacher assigning educational systems consisting but not limited to games, apps, and quizzes; analyzing the assessment results and reports; and generating personalized reports.

FIG. 7 illustrates a block diagram of an ecosystem of the invention involving educators, students and educational system providers.

FIG. 8 is a flowchart depicting the system architecture of an embodiment of the present invention.

### DETAILED DESCRIPTION

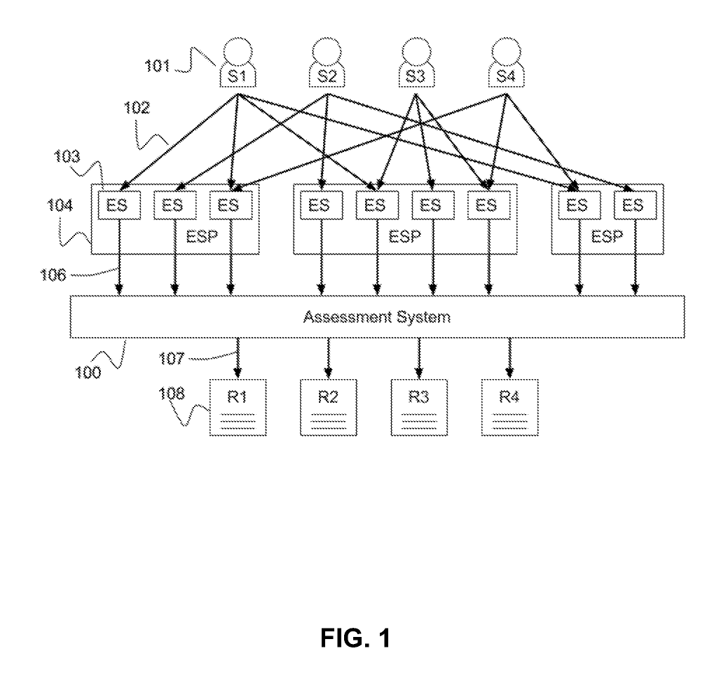

Referring to FIG. 1, the present invention provides a system, method and computer program product for real-time assessment from a plurality of applications from various digital educational system providers to deliver a unified reporting.

The system comprises (1) a software development kit (SDK) and application program interface (API) that allows any educational system provider to instrument their solution with the proposed system, so that the interaction of students with their educational system can be tracked; (2) an inference engine that gathers and analyzes interactions across multiple students and a broad array of educational systems, and infers both, the difficulty of each piece of content, and the understanding of each student; (3) a reporting tool for students or for educators following a group of students, expressing the level of understanding of each student and its progression over time.

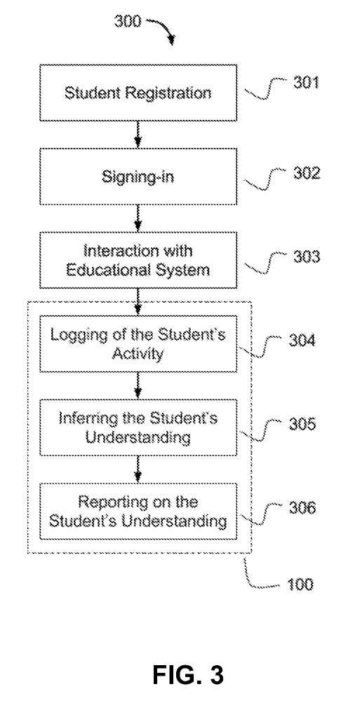

In an embodiment of the present invention as referred to FIG. 3, a service provider organization provides and allows access on registration, to a cloud-based tool that allows real-time assessment at the point of learning while a student interacts with multiple apps from various education system providers. The tool offered as an API to any digital educational system, allowing them to tracks in-app student performance to develop skills, to identify learning gaps and to drive deeply personalized learning recommendations for timely intervention. The system, method and computer program product take advantage of the ubiquity of digital and mobile learning devices in homes and schools. The service provider would provide a platform to its subscribers (e.g., students, teachers, educational system providers, individual teachers, educators, principals or school administrators, or entire schools, and school districts) to download applications (Software Development Toolkit and Application Program Interface in case of education system providers and educational apps, games, tests and quizzes for students, parents, teachers and/or educators), log applications activity data of students, analyze data and generate assessment reports in a single unified dashboard for all applications and that can be accessed by subscribers via the platform on demand. The tool would be used by subscribers to obtain both real-time and historical information, including trends to provide them with instant, simple, and actionable insight in making educational decisions.

The present invention is described in more detail herein. While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding elements in the several views of the drawings.

The term “educational system”, as used herein, is defined as any digital learning technology consisting of but not limited to digital games, apps, tests and quizzes.

The terms “games”, “apps”, “tests” and “quizzes” as used herein is intended to include any digital educational system that a student interacts with.

The term “educational system provider”, as used herein, is defined as any publisher or provider of educational system including, but not limited to, online educational web site developers, educational app and game developers.

The terms “teachers”, and “educators”, as used herein, are defined as anyone that delivers academic content to students.

The terms “user,” “subscriber,” “customer,” “student”, “parent”, “teacher,” “educator,” “school,” “school district,” “educational system provider” and the plural form of these terms may be used interchangeably throughout herein to refer to those who would access, use, and/or benefit from the tool that the present invention provides for real-time assessment at the point of learning in a single unified report while a student interacts with multiple digital learning applications from various education system providers.

The operational architecture of an embodiment of the present invention for a real-time Assessment System 100 according to the present invention across educational systems and across users, showing connectivity among the various components of the system is presented in FIG. 1 where four Students 101 are shown interacting with multiple Educational Systems (ES) 103 provided by three Educational System Providers (ESP) 104. As each ES has been instrumented with the API of the assessment system 100, the interaction of the students with any ES is being logged 106 and the logs are stored by the assessment system. Based on a joint analysis of these logs across all ESs and all students, the assessment system infers the understanding level of each student in the specific subject or topic taught by the ESs and a Reporting tool 107 produces a personalized Report 108 for each student.

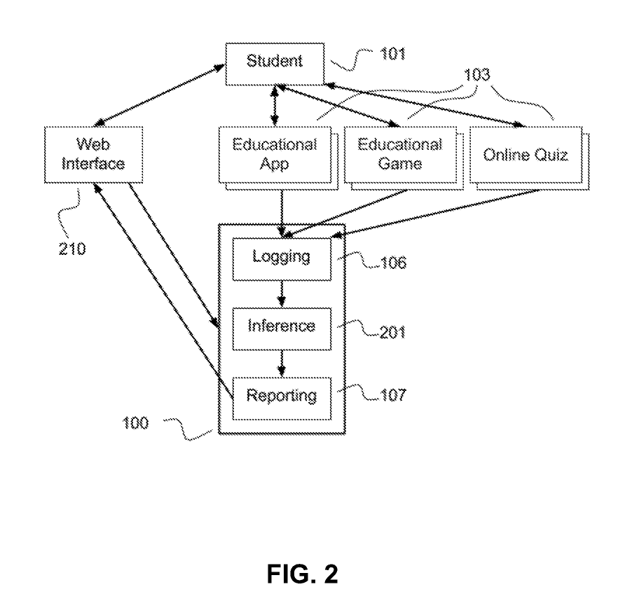

A teacher may use a variety of digital learning and assessment tools including mobile as well as online games, apps, tests and quizzes to infer a student's understanding of a subject matter or concept. FIG. 2 illustrates one embodiment of this invention, where a Student 101 interacts with multiple Educational Systems (ES) 103, possibly of different nature and from different Educational System Providers (ESP). While this interaction is taking place with anyone of these ESs, data representing this interaction is logged in the Assessment System 100 via its Logging Component 106. Upon request to the assessment system from the user via a User Interface 210, the assessment system runs its Inference Engine 201 and runs a Reporting tool 107 that produces a personalized report presented to the student in the web interface.

To use the services offered by the system provider, a user needs to register on the platform. FIG. 3 illustrates the student's registration process 300, and assessment from logging activity solution, which is a part of one embodiment of this invention. A student can register in the Assessment System 100. This Registration 301 does not need to collect any personally identifiable data (PII), but can just use a username which can be a non-PII nickname, as a registration credentials. Prior to interacting with an Educational System (ES) that uses the assessment system disclosed in this invention, the registered student has the choice to Sign-in 302 with his registration credentials. When the signed-in student interacts with an educational system 303, any activity data is logged 304 keyed with an encrypted form of the student's registration credentials. The key of any log is an encrypted version of the registration credentials so that on the one hand, given the student's credentials one can retrieve the student's activity logs; but on the other hand, given a keyed log one could not find the student it belongs to. This ensures student's privacy preservation, even if the logs were compromised, and even if the registration credentials would contain PII. The Inference engine 305 proceeds by grouping all the logs by key and therefore all the activity logs of a same signed-in student, across multiple activity sessions and across multiple educational systems, are assigned to a same student, and so is the final report 306.

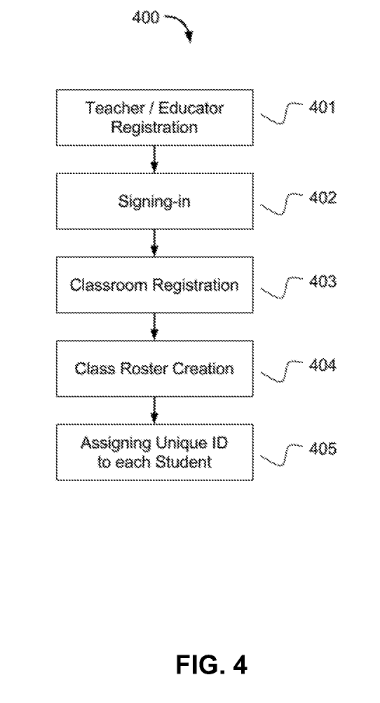

FIG. 4 illustrates another embodiment of the invention in a process 400 where the teacher registers on the system to create a class roster and assign students with their unique registration credentials. Once the teacher has registered herself 401 and after signing-in 402, she can create a class 403 and then a class roster 404. The teacher assigns a unique user ID to each Student 405 that is devoid of any PII. The students can use this ID to interact with educational content and system.

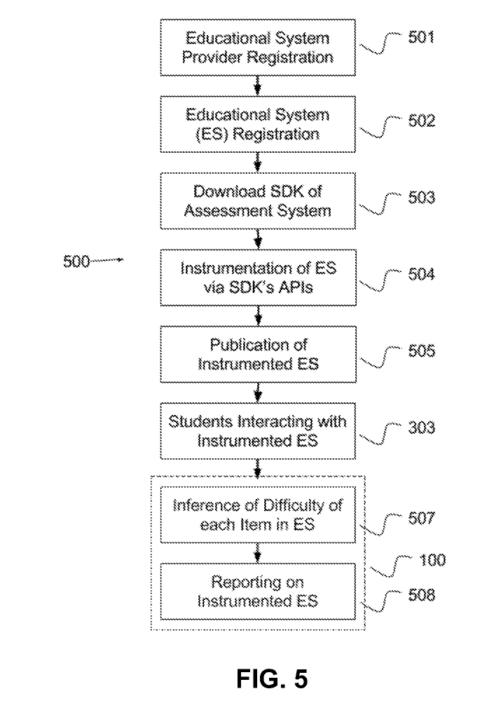

FIG. 5. Illustrates the registration process 500 for an Educational System Provider (ESP), the process to instrument an Educational System (ES) with the assessment system object of this invention, and the reporting for ESP. In order to use the assessment system, an ESP must first register with the assessment system via an ESP Registration process 501. In addition, each ES (e.g. an application running on a mobile device, a game, an online lecture with quiz) must be registered via an ES Registration process 502.

In order for the ES to interoperate with the assessment system, the ES has to be instrumented with the assessment system's software development kit (SDK) and its application program interface (API). For that, after obtaining the SDK 503 provided by the assessment system (e.g. from the internet), the ESP must extend the code 504 of each ES with calls to the API at each time a user of the ES takes an action such as start a problem, answer a question, complete a task. The new version of the ES must then be published 505 for the students to access it. As in FIG. 3, when students interact with the ES 303, the students' activity is logged by the assessment system 100. In addition to the inference of student level of understanding (depicted in FIG. 3), the assessment system also infers the difficulty of each item/task/question in the ES 507, and provides a report 508 about the ES to the ESP.

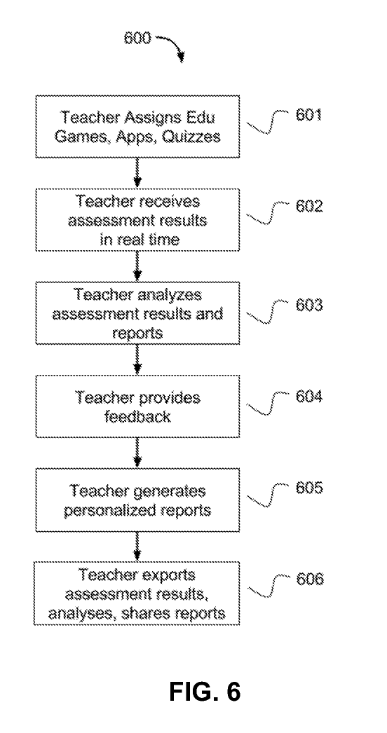

FIG. 6 illustrates the process 600 whereby teachers/educators can assign their students appropriate application(s) 601 for their subject and grade level from numerous available educational systems such as apps, games, tests and quizzes, from various educational system providers for their students to interact with. As students interact with these digital learning systems, data is logged and send instantly to a secure cloud server as long as there is internet connectivity.

The inference engine analyzes the data in real-time and sends back results on the performance of the learner 602 which can be accessed online by the users using their sign on credentials. Teacher looks at the real-time as well as historical data and trends on student performance 603 and provides feedback 604 to students. Teachers can also create personalized reports for each student 605 based on the analysis of the assessment reports. When teachers are part of a school or school district license, data and reports maybe shared with other educators and parents within the school system 606.

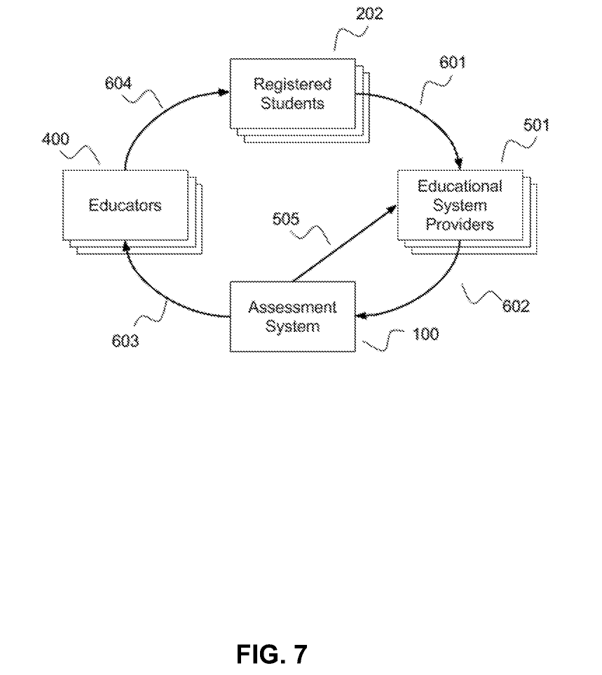

FIG. 7 Illustrates the eco-system of one possible embodiment of this invention, where a plurality of Educational System Providers (ESP) 401 are instrumenting their Educational Systems with the Assessment System 100 disclosed in this invention, so that when used, these Educational Systems (ES) send user activity data 502 to the Assessment System. A plurality of Registered Students 102 are interacting 501 with the ES. The inference engine of the assessment system processes the log data and produces reports of unified views of the level of understanding on a specific topic for each Registered Student based their interactions with multiple ESs. These reports are sent 503 to Educators in charge of teaching the Registered Students, and are used by the latter to give feedback and potentially complement of teaching 504 to their Registered Students. The assessment system can also produce reports for each ES about the difficulty of each item or question, reports which are sent 505 to the ESP, helping them to improve their content.

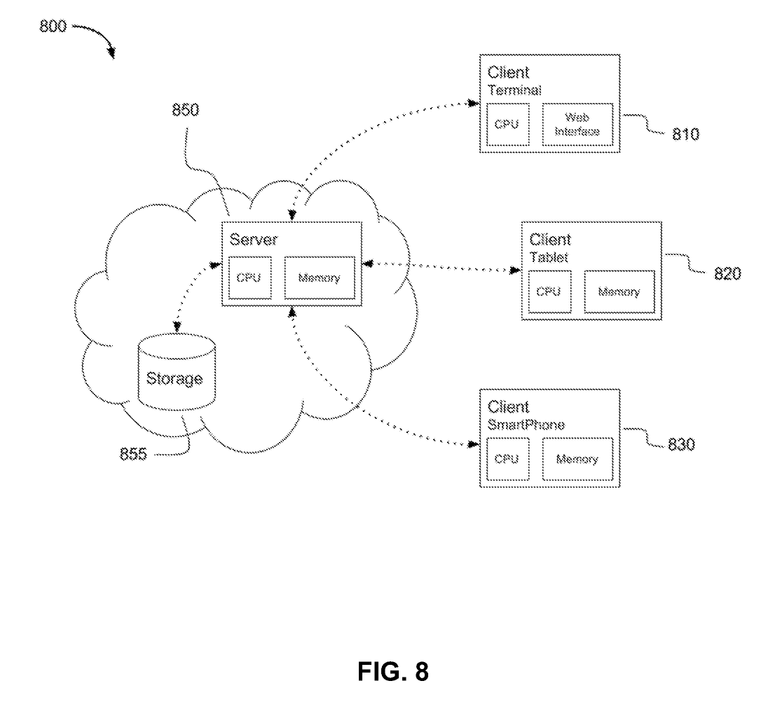

FIG. 8 illustrates the architecture 800 of one embodiment of this invention, where the assessment system is running on a server 850 in the cloud. The logs of students' activity are also stored in the cloud 855, possibly in a separate cloud service. The system is accessed via internet protocol requests made by client computers 810, 820, 830. The client computer 810 is a terminal client that has a web interface and is for example used by the educator to do the class registration and class roster, and to extract reports. Such a client can also be used by students to access educational systems (ESs) that are online. Other clients 820, 830 have their own CPU and memory (e.g. laptop, tablet computer, smartphone and other digital mobile devices) and are used by students interacting with ESs that are applications running on personal devices.

Those skilled in the art will recognize that the present invention has been described in terms of exemplary embodiments based upon use of a programmed processor and cloud based server. However, the invention should not be so limited, since the present invention could be implemented using hardware, software or a combination thereof and maybe implemented in one or more computer systems or other processing systems. Hardware component equivalents such as special purpose hardware and/or dedicated processors, which are equivalents to the invention as described could be used. Similarly, general purpose computers, microprocessor based computers, micro-controllers, optical computers, analog computers, programmable logic circuits, dedicated processors and/or dedicated hard wired logic may be used to construct alternative equivalent embodiments of the present invention.

The present invention, as described in embodiments herein, has been described as being implemented using a programmed processor executing programming instructions that are broadly described above in flow chart form that can be stored on any suitable computer readable storage medium (e.g., cloud servers, semiconductor storage, etc.) or transmitted over any suitable electronic communication medium. However, those skilled in the art will appreciate that the processes described above can be implemented in any number of variations without departing from the present invention.

While the invention has been described in conjunction with specific embodiments, it is evident that many alternatives, modifications, permutations and variations will become apparent to those of ordinary skill in the art in light of the foregoing description without departing from the spirit and scope of the invention. Thus, the present invention should not be limited by any of the exemplary embodiments described above, but should be defined only in accordance with the following claims and their equivalents.

I claim:

1. An assessment system for assessing a student's understanding in a subject, the assessment system using interactions of the student with multiple digital educational systems dedicated to one or more subjects and provided by multiple independent educational system providers, comprising:
a student log component that contains electronic student logs of the interaction of each student with each educational system;
a logging mechanism to record detailed interaction of each student with each educational system involved in the assessment;
an inference engine to jointly analyze the student logs from a plurality of students interacting with a plurality of educational systems, about a plurality of subjects, and inferring from that analysis the level of understanding of each student in some specific subjects; and
a reporting tool expressing the current level of understanding of each student in a specific subject and the evolution over time of the level of understanding.

2. An assessment system as recited in claim 1 with an application program interface used by the independent educational system providers to instrument their educational system so that each student activity in their educational system is logged by the assessment system.

3. An assessment system as recited in claim 1 where at least one of the educational systems is an application running on a mobile device such as a phone or a tablet computer.

4. An assessment system as recited in claim 1 where at least one of the educational systems is an application running on a laptop and desktop computer.

5. An assessment system as recited in claim 1 where at least one of the educational systems is an application running on a game console.

6. An assessment system as recited in claim 1 where at least one of the educational systems is an online interactive website.

7. An assessment system as recited in claim 1 where at least one of the educational systems is an educational game.

8. An assessment system as recited in claim 1 where at least one of the educational systems comprises a set questions.

9. An assessment system as recited in claim 8 where at least one of the questions has a yes or no answer.

10. An assessment system as recited in claim 8 where at least one of the questions is a multiple choice question.

11. An assessment system as recited in claim 8 where the inference engine evaluates both, the difficulty of each question on a particular subject, and the level of understanding of each student for the particular subject.

12. An assessment system as recited in claim 1 where the student log component is stored on a server computer.

13. An assessment system as recited in claim 12 where the educational systems are running on peripheral computers connected to the server computer via internet.

14. An assessment system as recited in claim 12 where the inference engine runs on the server computer.

15. An assessment system as recited in claim 12 where the reports are sent to peripheral computers.

16. An assessment system as recited in claim 1 where the student can register into the system via a registration mechanism.

17. An assessment system as recited in claim 16 where the registered student can identify himself to the system via a signing-in mechanism prior to some sessions of the student interacting with one of the educational systems.

18. An assessment system as recited in claim 17 where the inference engine identifies all the logs of interaction of the signed-in student across multiple sessions and across multiple educational systems, as belonging to the same signed-in student.

19. An assessment system as recited in claim 18 where a report is provided to the signed-in student based on the student's entire signed-in activity.

20. An assessment system as recited in claim 1 where a report is generated about the relative difficulty of each step of the educational system and is sent to the educational system provider.
